(19) United States
(12) Patent Application Publication
(10) Pub. No.: US 2026/0112010 A1
(43) Pub. Date: Apr. 23, 2026

(54) GENERATION OF ENHANCED HDR IMAGES BASED ON GAIN MAPS

(71) Applicant: Lemon Inc., Grand Cayman (KY)

(72) Inventors: Daniel Elwell, Los Angeles, CA (US); He Qin, Los Angeles, CA (US); Wenqing Jiang, Los Angeles, CA (US)

(21) Appl. No.: 18/919,321

(22) Filed: Oct. 17, 2024

(51) Int. Cl. G06T 5/92; G06V 10/56; G06V 10/60

(52) U.S. Cl. CPC G06T 5/92; G06V 10/56; G06V 10/60; G06T 2207/20208

(57) ABSTRACT

A computing system for generating a gain map-based enhanced High Dynamic Resolution (HDR) image receives an HDR image comprising a plurality of pixels, each pixel having one or a plurality of brightness values for each of a plurality of color components, applies at least a first tone mapping algorithm to each pixel in the HDR image, generates a gain map using the HDR image and the SDR image, generates a gain map-based enhanced HDR image based on the SDR image and the gain map, and generates an output based on the gain map-based enhanced HDR image.

### BACKGROUND

Imaging technologies have evolved to significantly advance visual quality, particularly with the advent of High Dynamic Range (HDR) imaging. HDR images and videos provide a greater range of luminosity and color depth compared to the Standard Dynamic Range (SDR) format. For example, HDR is characterized by brighter whites, darker blacks, and a wider potential number of visible colors, which result in more vivid and true-to-life images. This increased color depth and expanded dynamic range make HDR superior in delivering more immersive visual experiences, particularly when compared to the SDR format, which operates within a more limited color gamut and narrower range of brightness levels. With the growing adoption of HDR-enabled cameras and displays, especially in mobile devices, modern smartphones, tablets, and cameras now commonly support HDR imaging, bringing a professional-grade viewing experience to the consumer market.

However, while the HDR format has seen broad adoption and native support across various devices, the same cannot be said for enhanced HDR formats, which are designed to capture and display images and videos with additionally expanded dynamic range and color depth. Many devices on the market, including smartphones and digital cameras, lack the necessary hardware and software capabilities to natively capture and store images directly in enhanced HDR formats. This limitation hinders users from fully experiencing the benefits of enhanced HDR imaging, which includes more refined contrast, more accurate colors, and enhanced detail in both shadows and highlights.

### SUMMARY

In view of the above, a computing system is provided for generating a gain map-based enhanced High Dynamic Resolution (HDR) image. The computing system includes processing circuitry and memory storing instructions that, when executed, cause the processing circuitry to receive an HDR image comprising a plurality of pixels, each pixel having one or a plurality of brightness values for each of a plurality of color components. The processing circuitry is further caused to apply at least a first tone mapping algorithm to each pixel in the HDR image, thereby generating a Standard Dynamic Range (SDR) image with transformed brightness values for each of the plurality of color components, generate a gain map using the HDR image and the SDR image, generate a gain map-based enhanced HDR image based on the SDR image and the gain map, and generate an output based on the gain map-based enhanced HDR image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the second tone mapping algorithm in the SDR-to-enhanced HDR pipeline of the computing system of FIG. 1.

FIG. 3 is a flow chart of a first method for generating a gain map-based enhanced HDR image according to an example embodiment of the present disclosure.

FIG. 4 is a flow chart of a second method for generating a gain map-based enhanced HDR image according to an example embodiment of the present disclosure.

FIG. 5 shows an example computing environment of the present disclosure.

### DETAILED DESCRIPTION

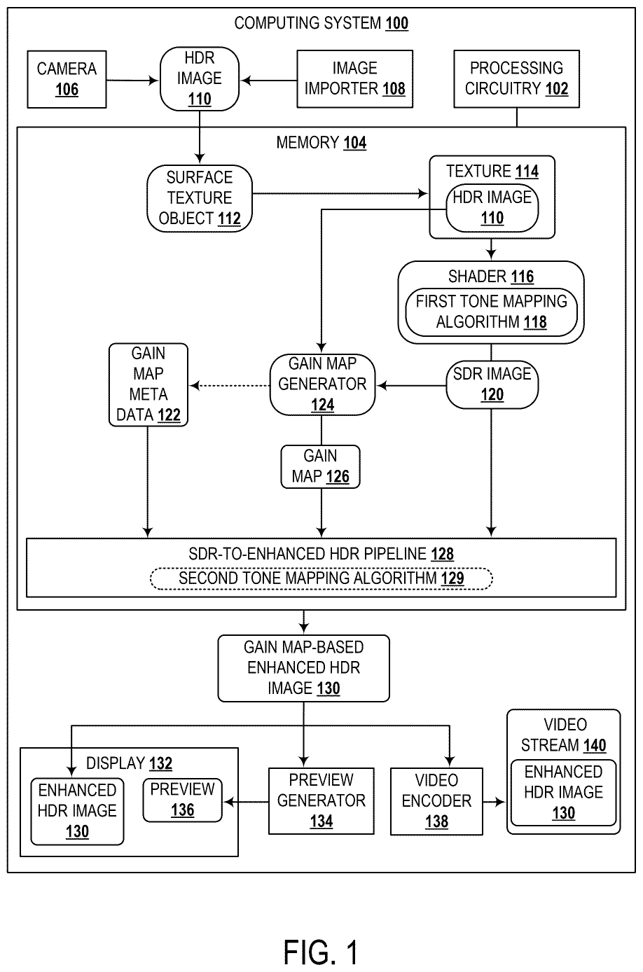

FIG. 1 shows a schematic view of an example computing system 100 for converting a High Dynamic Range (HDR) image 110 into a gain map-based enhanced HDR image 130. The example computing system 100 can be implemented with various types of computing devices, including mobile devices, smart phones, personal computers, laptops, computing servers, etc. The example computing system 100 includes processing circuitry 102 and memory 104 storing instructions that, during execution, causes the processing circuitry 102 to perform the various processes described herein. The processing circuitry 102 receives an HDR image 110 comprising a plurality of pixels. In the HDR image 110, each pixel has one or a plurality of brightness values for each of a plurality of color components. The processing circuitry 102 further applies at least a first tone mapping algorithm 118 to each pixel in the HDR image 110, thereby generating a Standard Dynamic Range (SDR) image 120 with transformed brightness values for each of the plurality of color components. Then a gain map 126 is generated using the HDR image 110 and the SDR image 120. An SDR-to-enhanced HDR pipeline 128 encodes the gain map-based enhanced HDR image 130 in an enhanced HDR format by directly using the SDR image 120 and the gain map 126.

An output is subsequently generated based on the gain map-based enhanced HDR image 130, which is encoded in an image encoding format that is configured to capture and display images with a dynamic range and/or color depth that are comparable to the standard HDR format. However, in alternative embodiments the gain map-based enhanced HDR image 130 may be encoded in an expanded dynamic range with a wider range of luminance levels and/or color values and/or higher bit depth compared to the standard HDR format. For example, the format of the gain map-based enhanced HDR image 130 may be configured to capture and display images with dynamic range and/or color depth that are comparable to other image formats, which may include, but are not limited to, Ultra-HDR, High-Efficiency Image File Format (HEIF), and other proprietary or open-standard formats. The enhanced HDR format of the gain map-based enhanced HDR image 130 may be backward compatible with the SDR format, so that the gain map-based enhanced HDR image 130 may be rendered on devices which lack native HDR support.

The processing circuitry 102 may execute a surface texture object 112 which receives and stores the HDR image 110 as a texture. The HDR image 110 may initially be processed by an image signal processor before being transferred to the memory 104. The HDR image 110 may be captured by a camera 106 which is included in the computing system 100. Alternatively, the HDR image 110 may be imported from various external sources by an image importer 108 and subsequently transferred into the memory 104. For example, the image importer 108 may be embodied as a capture hardware configured to capture the HDR image 110 from external cameras and transfer the image data into the memory 104.

When the HDR image 110 is streamed in real-time, the surface texture object 112 is configured to receive the HDR image 110 as a stream of image buffers from the camera 106. For example, the stream of image buffers may be captured in a capture session in which the camera 106 is configured to use the surface texture object 112 as its output destination. Accordingly, the capture session continuously streams the outputted HDR images 110 from the camera 106 to the surface texture object 112, which stores the HDR images 110 as textures. The capture session may be part of a live camera preview mode, a burst capture mode, or a timelapse mode, for example. The HDR image 110 may be transferred directly into the memory 104 in real-time via a high-speed communication interface, such as Universal Serial Bus (USB), Thunderbolt, or high-definition multimedia interface (HDMI). The high-speed communication interface may implement wireless technology via Wi-Fi transmission, Bluetooth, wireless HDMI, or cellular networks, for example.

The surface texture object 112 may use a buffer queue mechanism to manage the flow of the image buffers to the first tone mapping algorithm 118. The surface texture object 112 may update a texture 114, so that the latest HDR image 110 is loaded into the texture 114. Then the texture 114 is passed to a shader 116, which applies a first tone mapping algorithm 118 to the HDR image 110 to generate an SDR image 120 with transformed brightness values for each of the plurality of color components of the pixels of the HDR image 110. The first tone mapping algorithm 118 compresses the range of brightness values in the HDR image 110 to fit within the limits of a display 132 while preserving the visual details and contrast of the HDR image 110 to the furthest extent possible within the physical limitations of the display 132. The first tone mapping algorithm 118 may be configured to determine an adjustment factor of a given pixel of the HDR image 110 based on a peak luminance of the display 132, and scale each color component of the given pixel based on the adjustment factor. The HDR image 110 may have a wide-gamut Rec. 2020 color space with a color depth of 10 bits, while the SDR image 120 may have a narrow-gamut Rec. 709 color space with a color depth of 8 bits.

Examples of the first tone mapping algorithm 118 that can be used to generate the SDR image 120 include a linear function, a logarithmic function, an exponential function, Reinhard's formula, and filmic tone mapping operators, such as the Hable Tone Mapping Operator or the Academy Color Encoding System (ACES). Other functions included in the shader 116 may include an electro-optical transfer function and an opto-electric transfer function. The functions of the shader 116 may be applied to each pixel in the HDR image 110 in real-time as the surface texture object 112 receives HDR images 110 from the camera 106, such that the gain map-based enhanced HDR images 130, which are generated based on the HDR images 110, are outputted for rendering on the display 132 without perceptible delay.

The surface texture object 112 also passes the texture 114 to a gain map generator 124, which generates a gain map 126 based on the HDR image 110 and the SDR image 120. The gain map 126 encodes pixel data on the adjustment of brightness and contrast of the SDR image 120 in logarithmic space in one or a plurality of color components to convert the SDR image 120 to the enhanced HDR format. The gain map 126 is expressed as a scalar function in logarithmic space, relative to a maximum content boost value and a minimum content boost value, to define transitions in brightness levels between the SDR format and the enhanced HDR format. The minimum content boost value defines how much darker the enhanced HDR image 130 can become relative to the SDR image 120. The maximum content boost value defines how much brighter the enhanced HDR image 130 can become relative to the SDR image 120.

The SDR-to-enhanced HDR pipeline 128 encodes the gain map-based enhanced HDR image 130 by directly using the SDR image 120 and the gain map 126, and an output is generated based on the gain map-based enhanced HDR image 130. When the gain map-based enhanced HDR image 130 is encoded to be displayed on the display 132, a second tone mapping algorithm 129 may be applied to the SDR image 120, based on the gain map 126, to generate the gain map-based enhanced HDR image 130. The gain map-based enhanced HDR image 130 may be outputted for rendering on a display 132 and/or encoded by an image encoder 138 to generate and output a video stream 140 incorporating the gain map-based enhanced HDR image 130. The display 132 may be a display device within the computing system 100 or an external device that is communicatively coupled to the computing system 100.

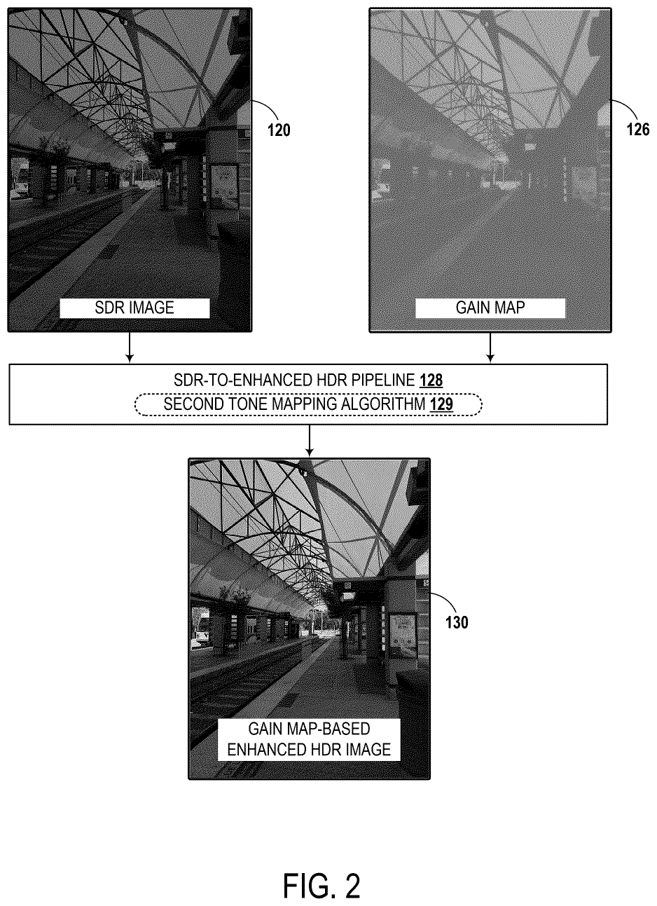

Turning to FIG. 2, in one example implementation, the SDR image 120, the gain map 126, and gain map metadata 122 are received by an SDR-to-enhanced HDR pipeline 128 and processed to generate a gain map-based enhanced HDR image 130. The gain map metadata 122 may be generated by the gain map generator 124, or configured manually or automatically based on technical settings of the camera 106. For example, the gain map metadata 122 may describe a dynamic range and a resolution of the gain map-based enhanced HDR image 130 based on the resolution, peak luminance, and display condition of the display 132, so that the enhanced HDR image 130 may be rendered with consistency across different types and models of displays and display conditions. The second tone mapping algorithm 129 in the SDR-to-enhanced HDR pipeline 128 may be applied to each pixel in the SDR image 120 to generate the gain map-based enhanced HDR image 130 for rendering on a display. The second tone mapping algorithm 129 may be configured to determine an adjustment factor of a given pixel of the SDR image 120 based on a peak luminance of the display 132 and the gain map 126, and scale each color component of the given pixel based on the adjustment factor.

Returning to FIG. 1, the gain map-based enhanced HDR image 130 may be outputted for rendering on the display 132 and/or encoded by the video encoder 138 to generate and output a video stream 140 incorporating the gain map-based enhanced HDR image 130. A preview generator 134 may also be executed to generate a preview 136 for rendering on the display 132 based on the gain map-based enhanced HDR image 130 before a user authorizes the video encoder 138 to generate a video stream 140 for sharing. For example, a preview 136 may be rendered on the display 132 based on the gain map-based enhanced HDR image 130, a user input may be received to authorize the generation of a video stream 140, and responsive to receiving the user input, the video encoder 138 generates the video stream 140 for sharing the gain map-based enhanced HDR image 130.

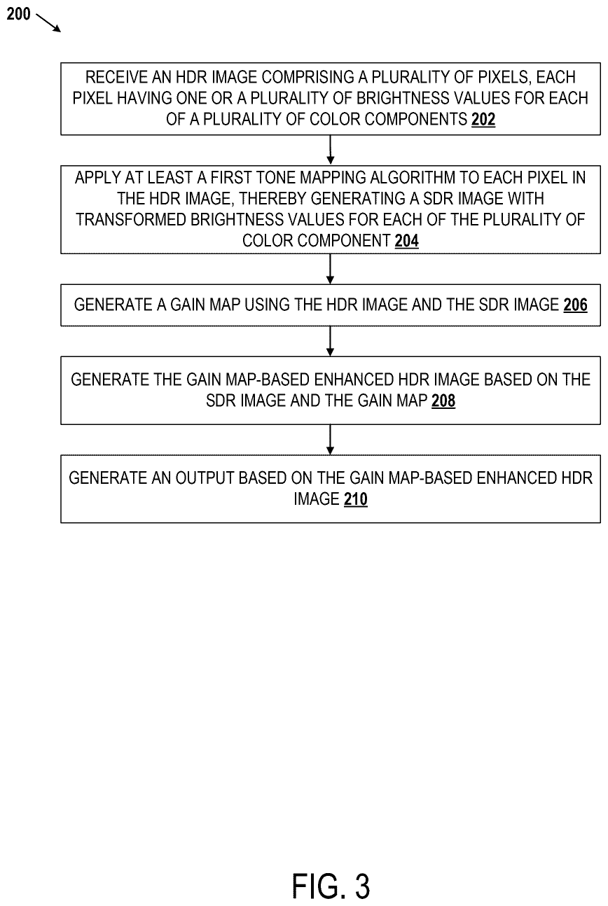

FIG. 3 shows a process flow diagram of a first example method 200 for generating a gain map-based enhanced HDR image. The first example method 200 may be executed by the processing circuitry 102 and memory 104 of the computing system 100 of FIG. 1. The first example method 200 includes, at step 202, receiving an HDR image comprising a plurality of pixels, each pixel having one or a plurality of brightness values for each of a plurality of color components. The first example method 200 includes, at step 204, applying at least a first tone mapping algorithm to each pixel in the HDR image, thereby generating a SDR image with transformed brightness values for each of the plurality of color component.

At step 206, the method 200 includes generating a gain map using the HDR image and the SDR image. At step 208, the method 200 includes generating the gain map-based enhanced HDR image based on the SDR image and the gain map. At step 210, the method 200 includes generating an output based on the gain map-based enhanced HDR image.

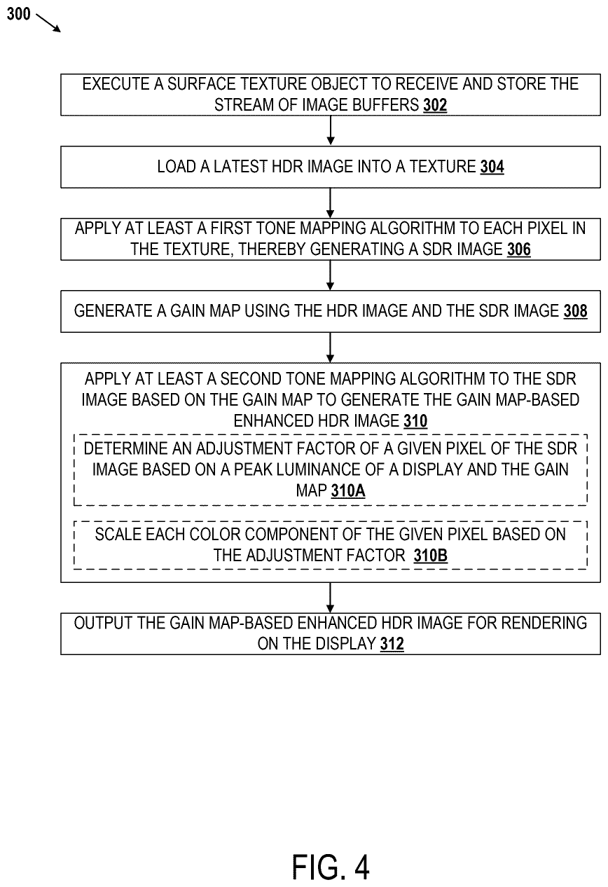

FIG. 4 shows a process flow diagram of a second example method 300 for generating a gain map-based enhanced HDR image. The second example method 300 may be executed by the processing circuitry 102 and memory 104 of the computing system 100 of FIG. 1. The second example method 300 includes, at step 302, executing a surface texture object to receive and store the stream of image buffers, and, at step 304, loading a latest HDR image into a texture. The second example method 300 includes, at step 306, applying at least a first tone mapping algorithm to each pixel in the texture, thereby generating a SDR image.

At step 308, the method 300 includes generating a gain map using the HDR image and the SDR image. At step 310, the method 300 includes applying at least a second tone mapping algorithm to the SDR image based on the gain map to generate the gain map-based enhanced HDR image. Step 310 may include step 310A of determining an adjustment factor of a given pixel of the SDR image based on a peak luminance of a display and the gain map, and step 310B of scaling each color component of the given pixel based on the adjustment factor. At step 312, the method 300 includes outputting the gain map-based enhanced HDR image for rendering on the display.

As described throughout herein, by converting HDR images into SDR format and then using gain maps to generate gain map-based enhanced HDR images, users can still generate enhanced HDR images using older devices with hardware that do not natively capture images directly in the enhanced HDR format. Accordingly, users can still fully experience the benefits of enhanced HDR imaging by leveraging existing HDR imaging capabilities in their devices. Furthermore, the quality of images and videos created with older devices can be increased to further refine the image contrast, increase the accuracy of rendered colors, and enhance detail in both shadows and highlights.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

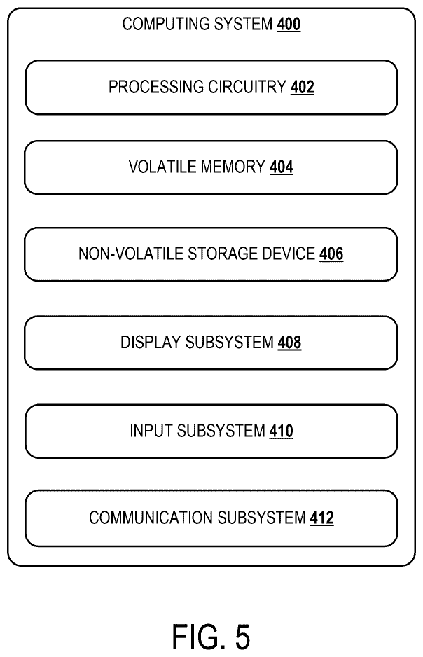

FIG. 5 schematically shows a non-limiting embodiment of a computing system 400 that can enact one or more of the methods and processes described above. Computing system 400 is shown in simplified form. Computing system 400 may embody the computing system 100 described above and illustrated in FIG. 1. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 5.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 402 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines. These different physical logic processors of the different machines will be understood to be collectively encompassed by processing circuitry 402.

Non-volatile storage device 406 includes one or more physical devices configured to hold instructions executable by the processing circuitry to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. It will be appreciated that volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, camera, or microphone.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 400 to send and/or receive messages to and/or from other devices via a network such as the Internet.

The following paragraphs provide additional description of the subject matter of the present disclosure. One aspect provides computing system for generating a gain map-based enhanced High Dynamic Resolution (HDR) image, the computing system comprising processing circuitry and memory storing instructions that, when executed, cause the processing circuitry to receive an HDR image comprising a plurality of pixels, each pixel having one or a plurality of brightness values for each of a plurality of color components, apply at least a first tone mapping algorithm to each pixel in the HDR image, thereby generating a Standard Dynamic Range (SDR) image with transformed brightness values for each of the plurality of color components, generate a gain map using the HDR image and the SDR image, generate a gain map-based enhanced HDR image based on the SDR image and the gain map, and generate an output based on the gain map-based enhanced HDR image.

In this aspect, additionally or alternatively, the gain map-based enhanced HDR image may be outputted for rendering on a display, the gain map-based enhanced HDR image may be generated by applying at least a second tone mapping algorithm to the SDR image based on the gain map, and the second tone mapping algorithm may be configured to determine an adjustment factor of a given pixel of the enhanced HDR image based on a peak luminance of the display and the gain map, and scale each color component of the given pixel based on the adjustment factor.

In this aspect, additionally or alternatively, the gain map-based enhanced HDR image may be encoded to be backward compatible with an SDR format.

In this aspect, additionally or alternatively, the HDR image may be streamed in real-time, and a surface texture object may be executed to receive the HDR image as a stream of image buffers.

In this aspect, additionally or alternatively, the computing system may further comprise a camera, and the stream of image buffers may be received from the camera in a capture session.

In this aspect, additionally or alternatively, the capture session may be one of a live camera preview mode, a video recording mode, a live streaming mode, a burst capture mode, or a timelapse mode.

In this aspect, additionally or alternatively, the stream of image buffers may be received from a video stream.

In this aspect, additionally or alternatively, the gain map may be expressed as a scalar function in logarithmic space.

In this aspect, additionally or alternatively, the first tone mapping algorithm may be applied to each pixel in the HDR image to further generate gain map metadata, and the second tone mapping algorithm may be applied to the SDR image, based on the gain map and the gain map metadata, to generate the gain map-based enhanced HDR image.

In this aspect, additionally or alternatively, the gain map metadata may describe a dynamic range and a resolution of the gain map-based enhanced HDR image.

Another aspect provides a computing method for generating a gain map-based enhanced High Dynamic Resolution (HDR) image, the computing method comprising receiving an HDR image comprising a plurality of pixels, each pixel having one or a plurality of brightness values for each of a plurality of color components, applying at least a first tone mapping algorithm to each pixel in the HDR image, thereby generating a Standard Dynamic Range (SDR) image with transformed brightness values for each of the plurality of color components, generating a gain map using the HDR image and the SDR image, generating a gain map-based enhanced HDR image based on the SDR image and the gain map, and generating an output based on the gain map-based enhanced HDR image.

In this aspect, additionally or alternatively, the gain map-based enhanced HDR image may be outputted for rendering on a display, the gain map-based enhanced HDR image may be generated by applying at least a second tone mapping algorithm to the SDR image based on the gain map, and the second tone mapping algorithm may be configured to determine an adjustment factor of a given pixel of the enhanced HDR image based on a peak luminance of the display and the gain map, and scale each color component of the given pixel based on the adjustment factor.

In this aspect, additionally or alternatively, the gain map-based enhanced HDR image may be encoded to be backward compatible with an SDR format.

In this aspect, additionally or alternatively, the HDR image may be streamed in real-time, and a surface texture object may be executed to receive the HDR image as a stream of image buffers.

In this aspect, additionally or alternatively, the stream of image buffers may be received from a camera in a capture session.

In this aspect, additionally or alternatively, the capture session may be one of a live camera preview mode, a video recording mode, a live streaming mode, a burst capture mode, or a timelapse mode.

In this aspect, additionally or alternatively, the stream of image buffers may be received from a video stream.

In this aspect, additionally or alternatively, the gain map may be expressed as a scalar function in logarithmic space.

In this aspect, additionally or alternatively, the first tone mapping algorithm may be applied to each pixel in the HDR image to further generate gain map metadata, and the second tone mapping algorithm may be applied to the SDR image, based on the gain map and the gain map metadata, to generate the gain map-based enhanced HDR image.

Another aspect provides a computing system for generating a gain map-based enhanced High Dynamic Resolution (HDR) image, the computing system comprising a camera, processing circuitry, and memory storing instructions that, when executed, cause the processing circuitry to receive a plurality of HDR images as a stream of image buffers from the camera, execute a surface texture object to receive and store the stream of image buffers, and load a latest HDR image into a texture, apply at least a first tone mapping algorithm to each pixel in the texture, thereby generating a Standard Dynamic Range (SDR) image, generate a gain map using the HDR image and the SDR image, generate a gain map-based enhanced HDR image based on the SDR image and the gain map, and output the gain map-based enhanced HDR image for rendering on a display.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a gain map-based enhanced High Dynamic Resolution (HDR) image, the computing system comprising:
processing circuitry and memory storing instructions that, when executed, cause the processing circuitry to:
receive an HDR image comprising a plurality of pixels, each pixel having one or a plurality of brightness values for each of a plurality of color components;
apply at least a first tone mapping algorithm to each pixel in the HDR image, thereby generating a Standard Dynamic Range (SDR) image with transformed brightness values for each of the plurality of color components;
generate a gain map using the HDR image and the SDR image;
generate a gain map-based enhanced HDR image based on the SDR image and the gain map; and
generate an output based on the gain map-based enhanced HDR image.

2. The computing system of claim 1, wherein
the gain map-based enhanced HDR image is outputted for rendering on a display;
the gain map-based enhanced HDR image is generated by applying at least a second tone mapping algorithm to the SDR image based on the gain map; and
the second tone mapping algorithm is configured to determine an adjustment factor of a given pixel of the enhanced HDR image based on a peak luminance of the display and the gain map, and scale each color component of the given pixel based on the adjustment factor.

3. The computing system of claim 1, wherein the gain map-based enhanced HDR image is encoded to be backward compatible with an SDR format.

4. The computing system of claim 1, wherein
the HDR image is streamed in real-time; and
a surface texture object is executed to receive the HDR image as a stream of image buffers.

5. The computing system of claim 4, further comprising a camera, wherein the stream of image buffers is received from the camera in a capture session.

6. The computing system of claim 5, wherein the capture session is one of a live camera preview mode, a video recording mode, a live streaming mode, a burst capture mode, or a timelapse mode.

7. The computing system of claim 4, wherein the stream of image buffers is received from a video stream.

8. The computing system of claim 1, wherein the gain map is expressed as a scalar function in logarithmic space.

9. The computing system of claim 1, wherein
the first tone mapping algorithm is applied to each pixel in the HDR image to further generate gain map metadata; and
the second tone mapping algorithm is applied to the SDR image, based on the gain map and the gain map metadata, to generate the gain map-based enhanced HDR image.

10. The computing system of claim 9, wherein the gain map metadata describes a dynamic range and a resolution of the gain map-based enhanced HDR image.

11. A computing method for generating a gain map-based enhanced High Dynamic Resolution (HDR) image, the computing method comprising:
receiving an HDR image comprising a plurality of pixels, each pixel having one or a plurality of brightness values for each of a plurality of color components;
applying at least a first tone mapping algorithm to each pixel in the HDR image, thereby generating a Standard Dynamic Range (SDR) image with transformed brightness values for each of the plurality of color components;
generating a gain map using the HDR image and the SDR image;
generating a gain map-based enhanced HDR image based on the SDR image and the gain map; and
generating an output based on the gain map-based enhanced HDR image.

12. The computing method of claim 11, wherein
the gain map-based enhanced HDR image is outputted for rendering on a display;
the gain map-based enhanced HDR image is generated by applying at least a second tone mapping algorithm to the SDR image based on the gain map; and
the second tone mapping algorithm is configured to determine an adjustment factor of a given pixel of the enhanced HDR image based on a peak luminance of the display and the gain map, and scale each color component of the given pixel based on the adjustment factor.

13. The computing method of claim 11, wherein the gain map-based enhanced HDR image is encoded to be backward compatible with an SDR format.

14. The computing method of claim 11, wherein
the HDR image is streamed in real-time; and
a surface texture object is executed to receive the HDR image as a stream of image buffers.

15. The computing method of claim 14, wherein the stream of image buffers is received from a camera in a capture session.

16. The computing method of claim 15, wherein the capture session is one of a live camera preview mode, a video recording mode, a live streaming mode, a burst capture mode, or a timelapse mode.

17. The computing method of claim 14, wherein the stream of image buffers is received from a video stream.

18. The computing method of claim 11, wherein the gain map is expressed as a scalar function in logarithmic space.

19. The computing method of claim 11, wherein
the first tone mapping algorithm is applied to each pixel in the HDR image to further generate gain map metadata; and
the second tone mapping algorithm is applied to the SDR image, based on the gain map and the gain map metadata, to generate the gain map-based enhanced HDR image.

20. A computing system for generating a gain map-based enhanced High Dynamic Resolution (HDR) image, the computing system comprising:
a camera;
processing circuitry; and
memory storing instructions that, when executed, cause the processing circuitry to:
receive a plurality of HDR images as a stream of image buffers from the camera;
execute a surface texture object to receive and store the stream of image buffers, and load a latest HDR image into a texture;
apply at least a first tone mapping algorithm to each pixel in the texture, thereby generating a Standard Dynamic Range (SDR) image;
generate a gain map using the HDR image and the SDR image;
generate a gain map-based enhanced HDR image based on the SDR image and the gain map; and
output the gain map-based enhanced HDR image for rendering on a display.
